(19) United States
(12) Patent Application Publication
(10) Pub. No.: US 2024/0404310 A1
(43) Pub. Date: Dec. 5, 2024

(54) DOCUMENT READING APPARATUS THAT READS IMAGE OF DOCUMENT

(71) Applicant: KYOCERA Document Solutions Inc., Osaka (JP)

(72) Inventors: Joard SAQUILON, Osaka (JP); Aubrey Jean ABANES, Osaka (JP)

(73) Assignee: KYOCERA Document Solutions Inc., Osaka (JP)

(21) Appl. No.: 18/678,267

(22) Filed: May 30, 2024

(30) Foreign Application Priority Data
Jun. 5, 2023 (JP) 2023-092734

(51) Int. Cl. G06V 30/413; G06V 30/198; G06V 30/262; H04N 1/00

(52) U.S. Cl. CPC G06V 30/413; G06V 30/198; G06V 30/274; H04N 1/00461; H04N 2201/0094

(57) ABSTRACT

A document reading apparatus includes a display device, a document reading device, a controller, an information acquirer, and a word extractor. The document reading device reads an image of a document. The controller saves a file of image data, obtained through reading operation by the document reading device, in a storage device, with a file name assigned to the file. The information acquirer acquires information having high relevance to the document image, through a search engine using the document image represented by the image data as search criterion. The word extractor extracts, on a basis of character information included in the information acquired by the information acquirer, a prospective word for the file name out of a character group indicated by the character information. The controller assigns the prospective word for the file name extracted by the word extractor, to the file of the image data, as the file name.

### INCORPORATION BY REFERENCE

This application claims priority to Japanese Patent Application No. 2023-092734 filed on Jun. 5, 2023, the entire contents of which are incorporated by reference herein.

### BACKGROUND

The present disclosure relates to a document reading apparatus that reads an image of a document.

In recent years, a paperless filing system has come to be introduced in an increasing number of business offices and organizations, where images on paper documents are read by a scanner, and the image data is saved in the form of a file. To save a file, a file name has to be assigned to the file. However, it is troublesome for the user to create the file name appropriate for the content of the file. Besides, spending a long time to create the file name leads to an increase in time required for saving the file. Accordingly, some techniques to generate the file name, on the basis of the text in the file, have been proposed.

### SUMMARY

The disclosure proposes further improvement of the foregoing techniques.

In an aspect, the disclosure provides a document reading apparatus including a display device, a document reading device, and a control device. The document reading device reads an image of a document. The control device includes a processor, and acts as a controller, an information acquirer, and a word extractor, when the processor executes a control program. The controller saves a file of image data, obtained through reading operation by the document reading device, in a storage device, with a file name assigned to the file. The information acquirer acquires information having high relevance to the document image, through a search engine using the document image represented by the image data as search criterion. The word extractor extracts, on a basis of character information included in the information acquired by the information acquirer, a prospective word for the file name out of a character group indicated by the character information. The controller assigns the prospective word for the file name extracted by the word extractor, to the file of the image data, as the file name of the file.

### BRIEF DESCRIPTION OF THE DRAWINGS

FIG. 1 is a perspective view showing the appearance of an image forming apparatus, including a document reading apparatus according to a first embodiment of the disclosure;

FIG. 2 is a functional block diagram schematically showing an essential internal configuration of the image forming apparatus 1 according to the first embodiment;

FIG. 3A is a schematic drawing showing an example of a document image;

FIG. 3B and FIG. 3C include schematic drawings each showing an example of information having high relevance to the document image;

FIG. 4A is a schematic drawing showing another example of the document image;

FIG. 4B and FIG. 4C include schematic drawings each showing an example of information having high relevance to the document image;

FIG. 5A is a schematic drawing showing another example of the document image;

FIG. 5B includes schematic drawings each showing an example of information having high relevance to the document image;

FIG. 6A is a schematic drawing showing another example of the document image;

FIG. 6B includes schematic drawings each showing an example of information having high relevance to the document image;

FIG. 7 is a flowchart showing an example of a file name assignment process, performed by the image forming apparatus;

FIG. 8A is a schematic drawing showing another example of the document image;

FIG. 8B includes schematic drawings each showing an example of information having high relevance to the document image;

FIG. 9 is a functional block diagram schematically showing an essential internal configuration of an image forming apparatus according to a second embodiment;

FIG. 10 is a schematic drawing showing an example of the document image, including a plurality of images laid out therein; and

FIG. 11A and FIG. 11B include schematic drawings each showing an example of information having high relevance to the document image, with respect to each of the plurality of images.

### DETAILED DESCRIPTION

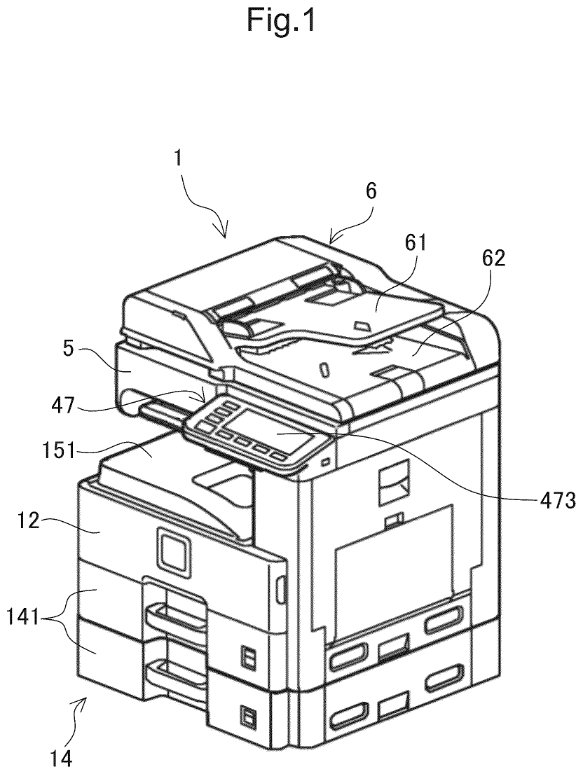

Hereafter, a document reading apparatus according to some embodiments of the disclosure will be described, with reference to the drawings. FIG. 1 is a perspective view showing the appearance of an image forming apparatus, including the document reading apparatus according to a first embodiment of the disclosure.

The image forming apparatus 1 is a multifunction peripheral having a plurality of functions, such as copying, printing, scanning, and facsimile transmission, and includes a control device 10, a document feeding device 6, a document reading device 5, an image forming device 12, a sheet feeding device 14, and an operation device 47.

The document feeding device 6 is openably connected to the upper face of the document reading device 5, for example via a non-illustrated hinge. The document feeding device 6 serves as a document retention cover, when a document placed on a non-illustrated platen glass is to be read. The document feeding device 6 is what is known as an automatic document feeder (ADF), and includes a document tray on which the document is placed, and a document discharge tray 62 provided on the lower side of the document tray 61. The document feeding device 6 delivers the documents placed on the document tray 61 to the document reading device 5 one by one, and then discharges the documents to the document discharge tray 62.

To perform the document reading operation, the image forming apparatus 1 operates as follows. The document reading device 5 optically reads the image on the document delivered from the document feeding device 6 to the document reading device 5, or placed on the platen glass, and generates image data. The image data generated by the document reading device 5 is stored, for example, in a non-illustrated image memory.

To perform the image forming operation, the image forming apparatus 1 operates as follows. The image forming device 12 forms a toner image on a recording sheet, exemplifying the recording medium in the disclosure, and delivered from the sheet feeding device 14, on the basis of the image data generated through the document reading operation, or image data received from an external device such as a computer, connected via the network.

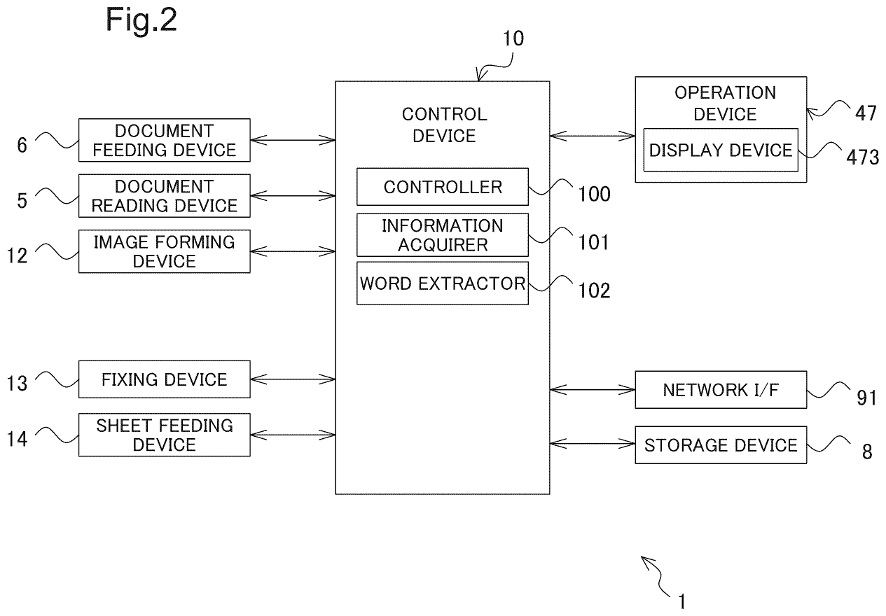

The recording sheet on which the toner image has been formed by the image forming device 12 is subjected to a fixing process in a fixing device 13 to be subsequently described (see FIG. 2). The recording sheet that has undergone the fixing process is delivered to an output tray 151. The sheet feeding device 14 includes a plurality of sheet cassettes 141.

The operation device 47 receives the user's instructions to execute the functions and operations that the image forming apparatus 1 is configured to perform, for example the image forming operation. The operation device 47 includes a display device 473 for displaying, for example, an operation guide for the user. The operation device 47 receives, through a touch panel provided on the display device 473, the user's instruction based on the touch operation performed by the user on the operation screen displayed on the display device 473, or on a physical key.

The display device 473 includes, for example, a liquid crystal display (LCD). The display device 473 includes the touch panel. When the user touches a button or a key displayed on the screen, the touch panel receives the instruction corresponding to the touched position.

FIG. 2 is a functional block diagram schematically showing an essential internal configuration of the image forming apparatus 1 according to the first embodiment. The image forming apparatus 1 includes a control device 10, the document feeding device 6, the document reading device 5, the image forming device 12, a fixing device 13, the sheet feeding device 14, the operation device 47, a network interface (I/F) 91, and a storage device 8.

The fixing device 13 heats and presses the recording sheet on which the toner image has been formed by the image forming device 12, to thereby fix the toner image onto the recording sheet. The recording sheet that has undergone the fixing process is delivered to the output tray 151 (see FIG. 1).

The network I/F 91 is a communication interface that transmits and receives various types of data to and from an external device (e.g., server) inside a local area, or on the internet.

The storage device 8 is a large-capacity storage device such as a hard disk drive (HDD) and a solid state drive (SSD), and contains various control programs.

The control device 10 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The control device 10 comprises a controller 100, an information acquirer 101, and a word extractor 102.

The control device 10 acts as the controller 100, the information acquirer 101, and the word extractor 102, when the processor operates according to the control program stored in the storage device 8. Here, the controller 100 and other functional components may be constituted in the form of a hardware circuit, instead of being realized by the operation of the control device 10 according to the control program. This also applies to other embodiments, unless otherwise specifically noted.

The controller 100 serves to control the overall operation of the image forming apparatus 1. The controller 100 is connected to the document feeding device 6, the document reading device 5, the image forming device 12, the fixing device 13, the sheet feeding device 14, the operation device 47, the network I/F 91, and the storage device 8, and controls the operation of the mentioned components.

For example, the controller 100 executes some processings required for the image forming operation to be performed by the image forming apparatus 1. In addition, the controller 100 saves a file of the image data, obtained through the reading operation by the document reading device 5, in the storage device 8, with a file name assigned to the file. Here, the controller 100 may transmit the file to an external device such as a personal computer, through the network I/F 91, to save the file in a storage device in the in external device.

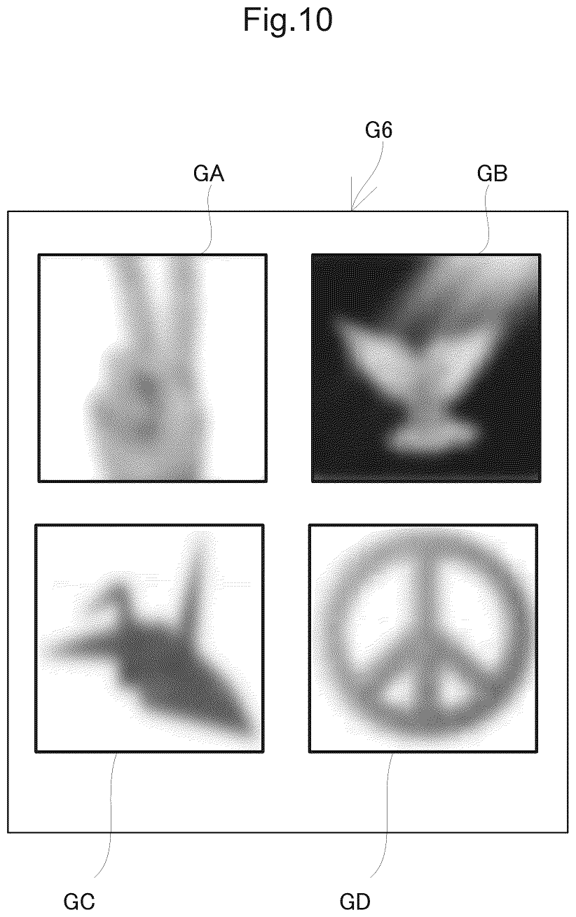

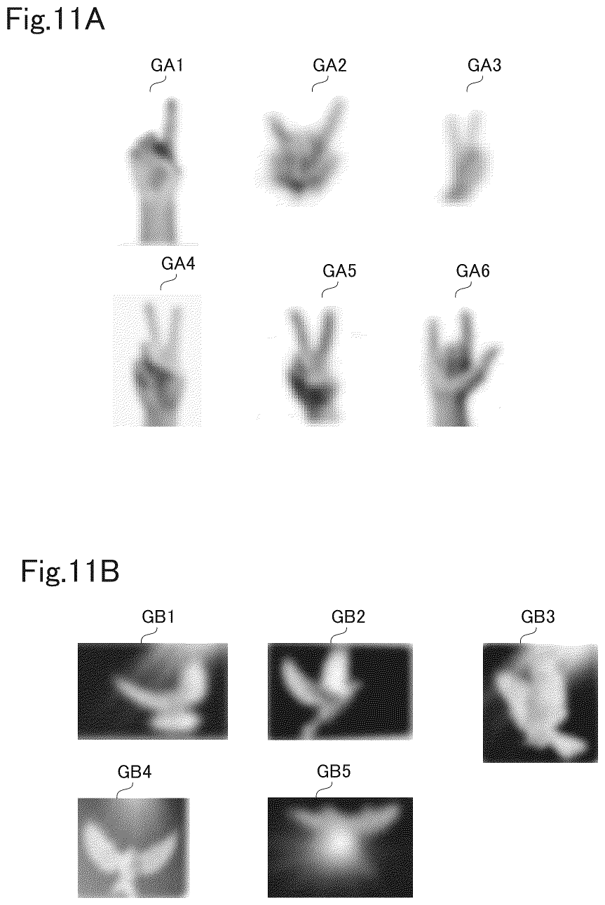

The information acquirer 101 acquires information having high relevance to the document image, through a search engine using the document image represented by the image data obtained through the reading operation by the document reading device 5, as the search criterion. For example, the information acquirer 101 may acquire the information having high relevance to the document image, from the internet through the network I/F 91, through a known search engine (e.g., Google or Bing), using the document image as the search criterion. Hereunder, examples of the acquisition of the information having high relevance to the document image, performed by the information acquirer 101 through the known search engine using the document image as the search criterion, will be described. In FIG. 10 and FIG. 11, the images displayed as the search result are intentionally blurred.

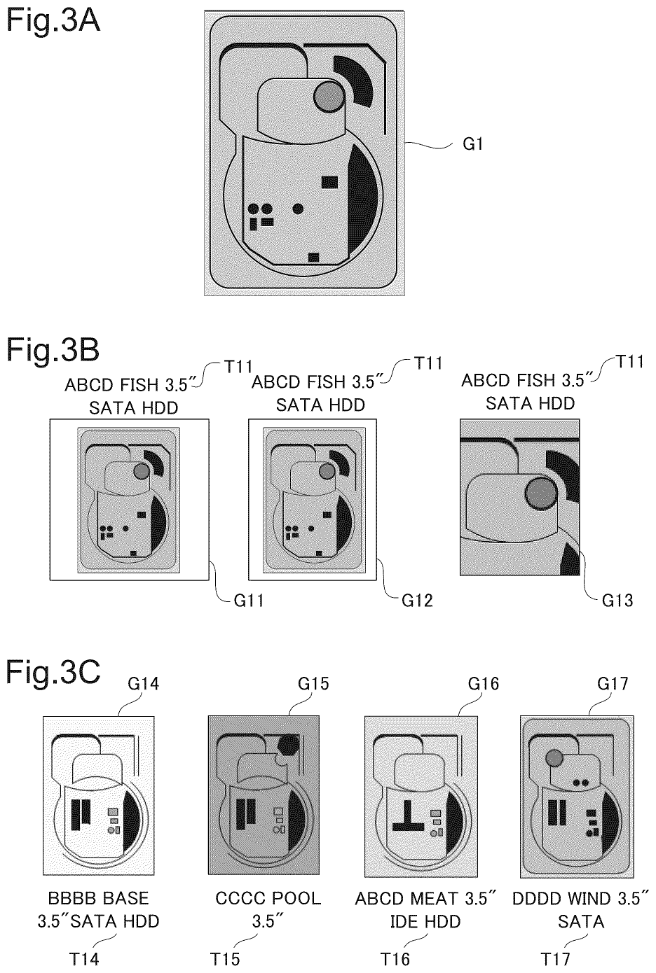

Here, it will be assumed that, as result of a search for similar images on the internet through the search engine, using a document image G1 (connection standard SATA for 3.5″ hard disk, trade name “FISH” manufactured by ABCD company) shown in FIG. 3A as the search criterion, images shown in FIGS. 3B and 3C have been retrieved, as information having high relevance to the document image G1. The search engine distinguishes between the images identical to the search object and images similar thereto, with a known technique, and presents those images as the search result. It is to be noted that the mentioned company name and the merchandise name are fictional, which also applies to the subsequent examples.

FIG. 3B indicates that, as the search result through the search engine, homogeneous mages G11 to G13 representing the same content as the document image G1, and character information T11 “ABCD FISH 3.5″ SATA HDD” indicating the title of the images G11 to G13, have been retrieved. In this case, since the images G11 to G13 are identical to the document image G1, the character information T11 is regarded as the character information indicating the document image G1 itself.

FIG. 3C indicates that, as the search result through the search engine, similar images G14 to G17 that are similar to the document image G1, and character information T14 to T17 respectively indicating the title of the images G14 to G17, have been retrieved.

As shown in FIG. 3B and FIG. 3C, the information acquirer 101 acquires the character information T11 indicating the title of the document image G1 itself, and the character information T14 to T17 respectively indicating the title of the images G14 to G17, which are similar to the document image G1, as the information having high relevance to the document image G1, in the category other than the image.

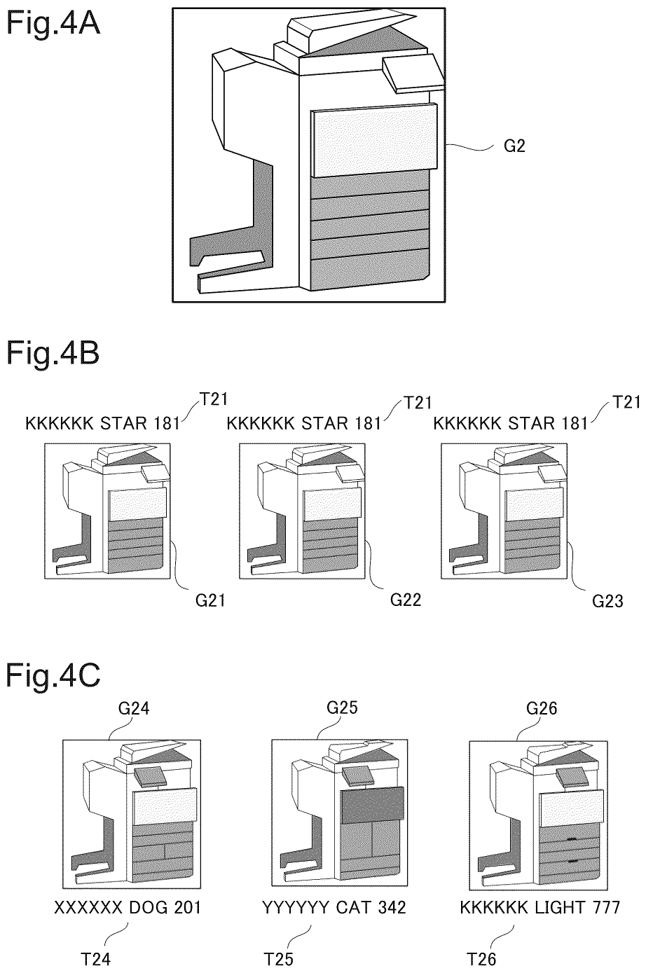

Referring to FIG. 4A, it will be assumed that, as result of a search for similar images on the internet through the search engine, using a document image G2 (multifunction peripheral “STAR 181” manufactured by KKKKKK company) as the search criterion, images shown in FIGS. 4B and 4C have been retrieved, as the information having high relevance to the document image G2.

FIG. 4B represents homogeneous mages G21 to G23 that are identical to the document image G2, and character information T21 “KKKKKK STAR 181” indicating the title of the images G21 to G23. Therefore, the character information T21 indicates the title of the document image G2 itself. FIG. 4C represents similar images G24 to G26 that are similar to the document image G2, and character information T24 to T26 respectively indicating the title of the images G24 to G26.

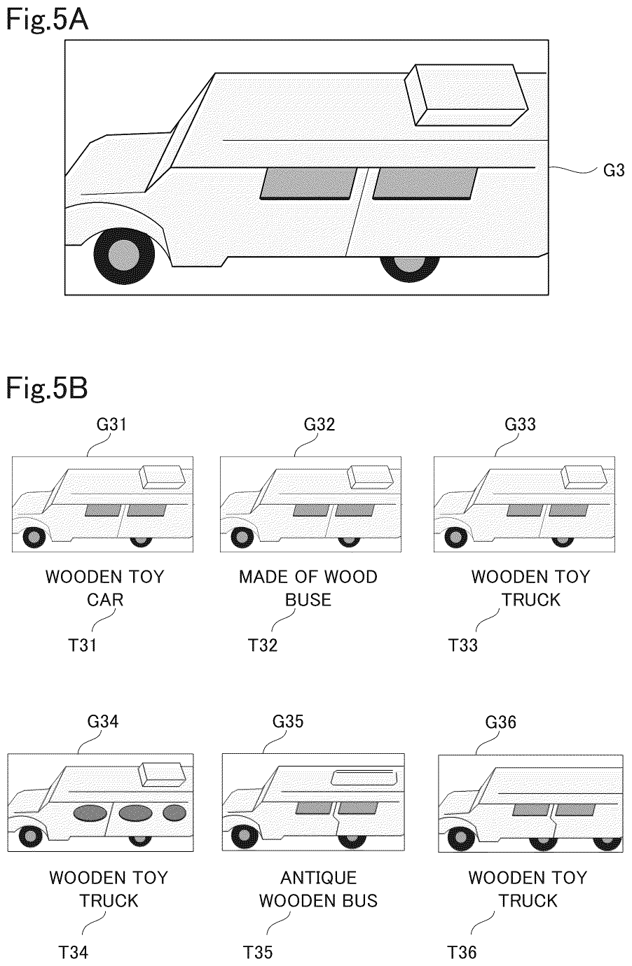

Referring to FIG. 5A, it will be assumed that, as result of a search on the internet through the search engine, using a document image G3 (wooden truck toy) as the search criterion, images shown in FIG. 5B have been retrieved, as the information having high relevance to the document image G3.

FIG. 5B represents similar images G31 to G36 that are similar to the document image G3, and character information T31 to T36 respectively indicating the title of the images G31 to G36. In this case, it is assumed that a homogeneous image regarded as identical to the document image G3 has not been retrieved, as result of the search using the document image G3 as the search criterion, unlike the case of using the document images G1 and G2 as the search criterion. Accordingly, although the information acquirer 101 acquires the character information T31 to T36 respectively indicating the title of the images G31 to G36, which are similar to the document image G3, as the information having high relevance to the document image G3, the information acquirer 101 is unable to acquire the character information indicating the title of the document image G3 itself.

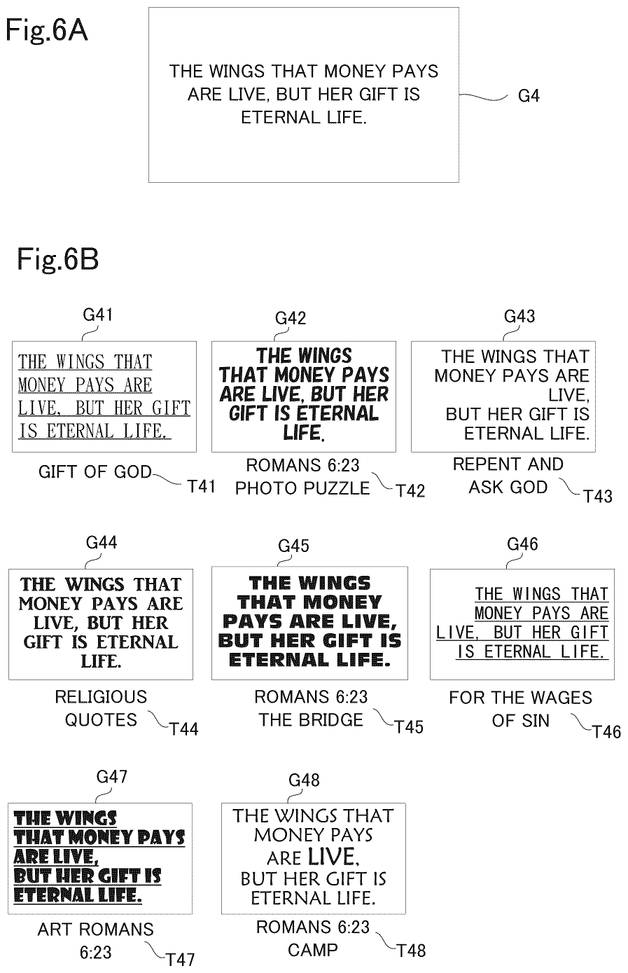

Referring to FIG. 6A, it will be assumed that, as result of a search on the internet through the search engine, using a document image G4 (a passage from a world-famous novel (fictional)) as the search criterion, images shown in FIG. 6B have been retrieved, as the information having high relevance to the document image G4.

FIG. 6B represents similar images G41 to G48 that are similar to the document image G4, and character information T41 to T48 respectively indicating the title of the images G41 to G48. In the case of using the document image G4 as the search criterion also, a homogeneous image regarded as identical to the document image G4 has not been retrieved, like the case of using the document image G3 as the search criterion.

The word extractor 102 extracts a prospective word for the file name, out of a character group indicated by the character information, on the basis of the character information included in the information acquired by the information acquirer 101. For example, when the information acquirer 101 has acquired the character information indicating the title of the document image itself, as the information having high relevance to the document image, the word extractor 102 may extract the prospective word for the file name, out of the character group indicated by the character information indicating the title of the document image itself, despite the similar images and the respectively corresponding character information having been retrieved as the search result. The word extractor 102 may extract the prospective word for the file name, either by randomly selecting one word out of the character information indicating the title of the document image itself, or by extracting a character string that appears in common in the character groups indicated by the character information.

When the information acquirer 101 has acquired the character information T11 “ABCD FISH 3.5″ SATA HDD” indicating the title of the document image G1 itself, as shown in FIG. 3B, the word extractor 102 extracts the prospective word for the file name, out of the character group indicated by the character information T11.

When the information acquirer 101 has acquired the character information T21 “KKKKKK STAR 181” indicating the title of the document image G2 itself, as shown in FIG. 4B, the word extractor 102 extracts the prospective word for the file name, out of the character group indicated by the character information T21.

Referring further to FIG. 3B, the word extractor 102 may either extract the entirety of “ABCD FISH 3.5″ SATA HDD”, or extract a predetermined appropriate number of characters. For example, when the appropriate number of characters is specified as 16 characters, the word extractor 102 may extract 16 characters as “ABCD FISH 3.5″ SATA”, excluding “HDD”, out of the character group indicated by the character information T11, as the prospective word for the file name.

In contrast, when the information acquirer 101 has not acquired the character information indicating the title of the document image itself, as the information having high relevance to the document image, but has only acquired the character information indicating the title of the similar images to the document image, the word extractor 102 extracts the word that frequently appears in the character groups indicated by the respectively corresponding character information about the similar images, as the prospective word for the file name.

For example, the word extractor 102 extracts the word that frequently appears in the character groups indicated by the respectively corresponding character information, on the basis of the character information T31 to T36 (or T41 to T48) indicating the title of the similar images to the document image G3 (or G4), as shown in FIG. 5 (or FIG. 6). The term “word that frequently appears” refers to a word that appears in two or more pieces of character information, among the character information retrieved as the search result.

In the character groups indicated by the character information T31 to T36, the frequently appearing words are “wooden”, “toy”, “truck”, “wooden toy”, and “wooden toy truck”. Examples of the word extracting method include (a) extracting the word that appears most frequently, namely “wooden”, and (b) extracting the word composed of a number of characters closest to a predetermined appropriate number of characters. For example, when the appropriate number of characters is specified as 16 characters, the word extractor 102 extracts the word “wooden toy truck”. Alternatively, the word extractor 102 may extract the word “eternal life” which appears most frequently, out of the character groups respectively corresponding to the character information T41 to T48.

Further, the controller 100 causes the display device 473 to display the word extracted by the word extractor 102, as the prospective word for the file name of the file corresponding to the image data, acquired through the reading operation by the document reading device 5, so that the user can check the word. Then the controller 100 determines the selected word as the file name, according to the user's instruction to select the file name, inputted through the operation device 47.

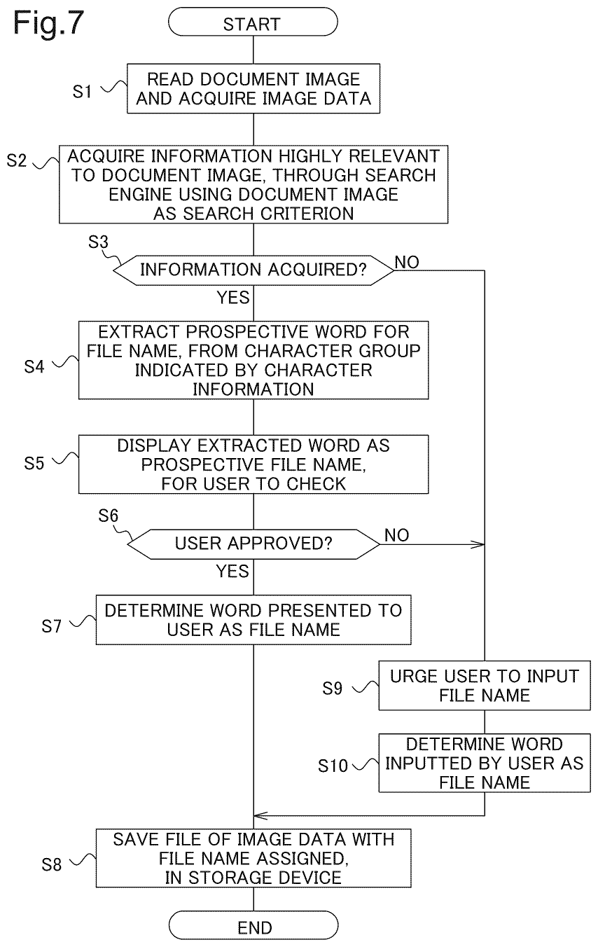

Referring now to a flowchart shown in FIG. 7, an example of a file name assignment process, performed by the image forming apparatus 1, will be described hereunder.

When a scanning instruction is inputted to the operation device 47 by the user, the controller 100 controls the operation of the document feeding device 6 and the document reading device 5, so as to read the image of a document placed on the document tray 61 or on the platen glass, thereby acquiring the image data of the document (S1).

The information acquirer 101 acquires the information having high relevance to the document image, through the search engine using the document image represented by the image data acquired by the controller 100, as the search criterion (S2). The controller 100 decides whether the information acquirer 101 has succeeded in acquiring the information (S3).

When the controller 100 decides that the information acquirer 101 has acquired the information (YES at S3), the word extractor 102 extracts the prospective word for the file name, out of the character group indicated by the character information, on the basis of the character information included in the information acquired by the information acquirer 101 (S4). When the document image, acquired according to the scanning instruction by the user is, for example, the document image G3 shown in FIG. 3A, the word extractor 102 extracts “ABCD FISH 3.5″ SATA” as the prospective word for the file name, on the basis of the character information associated with each of the images, presented as the search result indicating the identical image, to the image that is the object of the search.

The controller 100 causes the display device 473 to display the word extracted by the word extractor 102, as the prospective word for the file name of the file represented by the image data (S5), and decides whether an approval instruction, permitting that the prospective word is adopted as the file name, has been inputted by the user to the operation device 47 (S6).

Upon deciding that the approval instruction has been inputted to the operation device 47 (YES at S6), the controller 100 determines the prospective word as the file name of the file corresponding to the document image (S7), and saves the file in the storage device 8, with the determined file name assigned to the file (S8). Thereafter, the operation is finished.

In contrast, upon deciding that a disapproval instruction, rejecting the use of the prospective word for the file name, has been inputted to the operation device 47 (NO at S6), the controller 100 causes the display device 473 to display a file name input screen, urging the user to input a word to be assigned as the file name (S9). Then the controller 100 determines the word inputted by the user to the operation device 47, as the file name (S10), and saves the file in the storage device 8, with the file name determined as above assigned to the file (S8). Thereafter, the operation is finished.

Here, in the case where the disapproval instruction is inputted to the operation device 47, the controller 100 may cause the display device 473 to display a setting screen, for example presenting the current date and time as the file name to the user, and urging the user to approve the date and time as the file name. In this case, when the approval instruction of such file name is inputted to the operation device 47, the controller 100 determines such file name as the name of the file corresponding to the document image, and store the file in the storage device 8.

In the case where the controller 100 decides at S3 that the information acquirer 101 has failed to acquire the information (NO at S3), the operation proceeds to S9.

In this operation, further, the controller 100 may skip the step of S6, and immediately proceed to S7 and S8 after S5, without waiting for the approval of the user.

According to the first embodiment, when the file name is to be assigned to the image data representing the document image, the information having high relevance to the document image is acquired through the search engine, as result of the search performed using the document image as the search criterion. Then the word associated with the character information included in the acquired information is designated as the prospective word for the file name, and such prospective word is either assigned to the file, or presented to the user for approval. Accordingly, the file name appropriate for the content of the image data representing the document image can be assigned to the image data, or presented to the user for approval, even when the major part of the document image is occupied with photos or drawings. Therefore, the trouble to the user can be alleviated, and the time required for saving the file can be shortened.

Hereunder, a second embodiment of the disclosure will be described. The document images include those composed of characters and background only, without photos or drawings. When the content of the text is famous, like the example shown in FIG. 6A, the information acquirer 101 can acquire many pieces of information having high relevance to the document image, and commonly containing similar passages, through the search for the document image containing characters and background, and the word extractor 102 can extract the word appropriate as the file name (e.g., “eternal life” in the case of the document images shown in FIG. 6A).

However, when the text is unfamous (e.g., just a personal letter), the information having high relevance to the document image, acquired by the information acquirer 101 as result of the search for such a document image, may have insufficient points in common with one another, which may make it difficult for the word extractor 102 to extract the word appropriate as the file name.

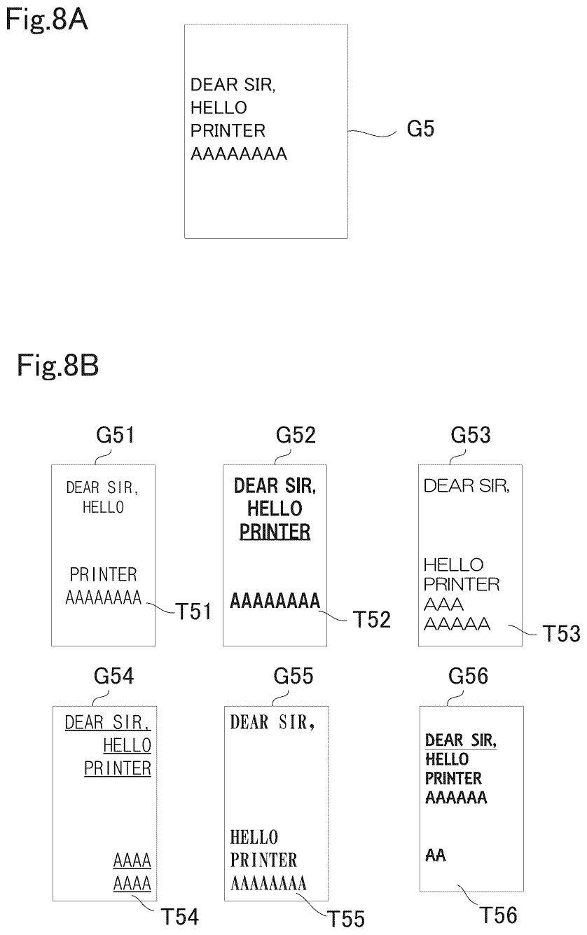

Here, it will be assumed that, as result of the search on the internet using as the search criterion a document image G5 shown in FIG. 8A, only composed of characters and background, which does not contain a famous text, the information shown in FIG. 8B has been acquired as the information having high relevance to the document image G5.

FIG. 8B includes character information T51 to T56, respectively associated with similar images G51 to G56, which are apparently similar to the document image G5. In this case, it is assumed that a homogeneous image, representing the identical content to the document image G5, has not been acquired as the search result. Further, since the object of the search is the image representing the unfamous text, it is unlikely that the similar images G51 to G56 are similar to one another, and that a word that commonly appears in the character groups, respectively corresponding to the character information T51 to T56, can be found out. Consequently, it is difficult to extract a word that is appropriate as the file name.

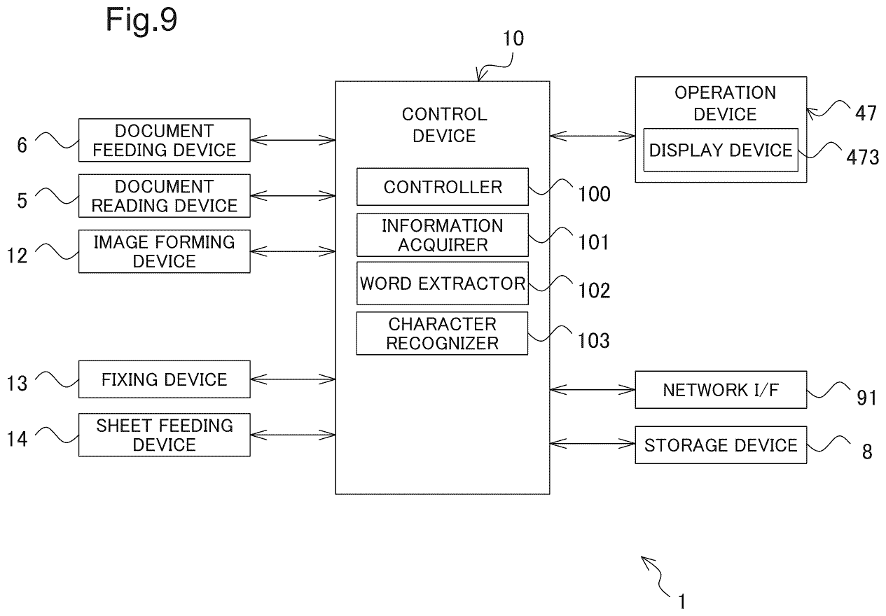

In the image forming apparatus 1 according to the second embodiment, therefore, the control device 10 further acts as a character recognizer 103, in addition to the controller 100, the information acquirer 101, and the word extractor 102, as shown in FIG. 9, when the processor executes the control program stored in the storage device 8. The character recognizer 103 recognizes the characters contained in the document image, using the known optical character recognition (OCR) technique.

In the second embodiment, the information acquirer 101 performs the search through the search engine, using as the search criterion the character group recognized by the character recognizer 103 from the document image, to thereby acquire the information having high relevance to the document image, as the search result. For example, in the case where the word extractor 102 has failed to extract a word that satisfies a predetermined word extracting condition, on the basis of the search result that has been acquired by the information acquirer 101 through the search for the document image, the information acquirer 101 performs the search through the search engine using as the search criterion the character group recognized by the character recognizer 103 from the document image, to thereby acquire the information having high relevance to the document image, as the search result. The word extractor 102 extracts the word for the file name, on the basis of the information acquired by the information acquirer 101 as result of the search using the character group as the search criterion. The predetermined word extracting condition refers to, for example, the case where a word that appears at least in half of the character groups, respectively associated with the character information T51 to T56, is found out.

Further, a third embodiment of the disclosure will be described hereunder. There are cases where the document image includes, as shown in FIG. 10, a plurality of images, different from one another, laid out on the document. A document image G6 shown in FIG. 10 contains images GA to GD, each representing an image different from others. The image GA represents a right hand, with the index finger and middle finger separately stretched. The image GB represents a flying pigeon. The image GC represents a paper crane. The image GD represents a circular symbol in which three lines are drawn.

When the information acquirer 101 acquires the information having high relevance to the document image G6, as result of the search through the search engine, using the document image G6 containing the plurality of images as the search criterion, it is unlikely that the images and the associated character information, presented as the search result, have a common content, since the document image G6 contains the plurality of images different from one another. Accordingly, even though the word extractor 102 attempts to extract the prospective word for the file name, on the basis of the information having high relevance to the document image G6, the word extractor 102 is likely to fail to extract an appropriate word for the file name.

In the third embodiment, therefore, the controller 100 divides the document image containing the plurality of images into each of the images, and the information acquirer 101 individually performs the search through the search engine, using each of the divided images as the search criterion, to thereby acquire the information having high relevance to the document image as the search result, with respect to each of the images. For example, the controller 100 detects the border lines among the image GA to GD, using a known line segment detection algorithm or edge detection technique, and divides the document image G6 into each of the images GA to GD, according to the border lines detected.

It is assumed here that, as result of the search performed by the information acquirer 101, through the search engine using the image GA (right hand with the index finger and middle finger separately stretched) as the search criterion, images GA1 to GA6 shown in FIG. 11A have been acquired, as the information having high relevance to the image GA as the search result, and also, though not shown, the character information associated with each of the images GA1 to GA6, such as “scissors”, “peace”, “peace symbol”, and “victory”, have been acquired.

It is also assumed here that, as result of the search performed by the information acquirer 101, through the search engine using the image GB (flying pigeon) as the search criterion, images GB1 to GB5 shown in FIG. 11B have been acquired, as the information having high relevance to the image GB as the search result, and also, though not shown, the character information associated with each of the images GB1 to GB5, such as “pigeon”, “peace”, and “peace symbol”, have been acquired.

It is also assumed that, when the information acquirer 101 acquires the information having high relevance to the image GC (paper crane), as result of the search through the search engine using the image GC as the search criterion, a plurality of non-illustrated images retrieved as the search result, and also the associated character information, such as “origami”, “crane”, “paper crane”, “peace”, and “peace symbol”, are acquired. Further, it is assumed that, when the information acquirer 101 acquires the information having high relevance to the image GD (circular symbol with three lines drawn therein), as result of the search through the search engine using the image GD as the search criterion, a plurality of non-illustrated images retrieved as the search result, and also the associated character information, such as “peace”, “peace symbol”, and “anti-war”, are acquired.

When the information acquirer 101 acquires the character information, as the search result with respect to each of the images GA1 to GA6 as mentioned above, the word extractor 102 extracts the prospective word for the file name, from each of the character groups indicated by the respectively corresponding character information, presented as the search result with respect to all of the images GA1 to GA6.

Therefore, even when the document image contains a plurality of images different from one another, the word extractor 102 can appropriately extract the prospective word for the file name, on the basis of the information having high relevance to the document image, which is common to the plurality of images.

In the first to third embodiments, the word extractor 102 is configured to extract a single word, as the prospective word for the file name. Instead, the word extractor 102 may be configured to extract one or more prospective words for the file name, and when two or more words are extracted, the controller 100 may cause the display device 473 to display a list of the prospective words for the file name, and determine the word selected by the user and inputted to the operation device 47, as the file name.

Now, in the case of the known technique to generate the file name on the basis of the text in the file, it is difficult to generate the file name when the document image is without characters, and the major part thereof is occupied with photos or drawings. In contrast, according to the foregoing embodiments, the information having high relevance to the document image can be acquired, through the search using an image, instead of characters, as the search criterion, and the word associated with the character information included in the relevant information is adopted as the file name. Accordingly, even when the major part of the document image is occupied with photos or drawings, the file name appropriate for the content of the document image can be assigned to the file of the document image. With the arrangement according to the foregoing embodiments, therefore, the trouble to the user can be alleviated, when the file name is to be assigned to the document image, and the time required for saving the file can be shortened.

The disclosure may be modified in various manners, without limitation to the foregoing embodiments. Further, the configurations and processings described in the foregoing embodiment and variations with reference to FIG. 1 to FIG. 11 are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is:

1. A document reading apparatus comprising:
a display device;
a document reading device that reads an image of a document; and
a control device including a processor, and configured to act, when the processor executes a control program, as:
a controller that saves a file of image data, obtained through reading operation by the document reading device, in a storage device, with a file name assigned to the file;
an information acquirer that acquires information having high relevance to the document image, through a search engine using the document image represented by the image data as search criterion; and
a word extractor that extracts, on a basis of character information included in the information acquired by the information acquirer, a prospective word for the file name out of a character group indicated by the character information,
wherein the controller assigns the prospective word for the file name extracted by the word extractor, to the file of the image data, as the file name of the file.

2. The document reading apparatus according to claim 1, further comprising an operation device that receives an input of a user's instruction,
wherein, when the word extractor extracts a word, the controller causes the display device to display the extracted word as the prospective word for the file name of the file, and determines the word selected by the user's instruction received by the operation device, as the file name.

3. The document reading apparatus according to claim 2,
wherein, in a case where the selection of the displayed word is not accepted, but an optional file name is inputted to the operation device, after the extracted word is displayed on the display device as the prospective word for the file name, the controller determines the optional file name inputted, as the file name of the file.

4. The document reading apparatus according to claim 1,
wherein the information acquirer acquires through the search engine, as the information having high relevance to the document image, an image identical to the document image and character information accompanying the identical image, and an image similar to the document image and character information accompanying the similar image, and
the word extractor extracts the prospective word for the file name, on a basis of the character information accompanying the identical image, or the character information accompanying the similar image.

5. The document reading apparatus according to claim 4,
wherein the word extractor extracts the prospective word for the file name, out of the character group indicated by the character information, on a basis of the character information accompanying the identical image, among the character information accompanying the identical image and the character information accompanying the similar image, acquired by the information acquirer.

6. The document reading apparatus according to claim 4,
wherein, when the information acquirer has acquired, as the search result, only the similar image and the character information accompanying the similar image, the word extractor extracts, on a basis of the character information accompanying the similar image, a word that frequently appears in the character group indicated by the character information, as the prospective word for the file name.

7. The document reading apparatus according to claim 1,
wherein the controller divides the document image, in which a plurality of images are arranged, into each of the plurality of images,
the information acquirer acquires the information having high relevance to each of the plurality of images, through individual searches through the search engine using each of the plurality of images as the search criterion, and
the word extractor extracts, on a basis of the character information included in the information having high relevance to each of the plurality of images, the prospective word for the file name, out of the character group indicated by the character information.

8. The document reading apparatus according to claim 1, further comprising a character recognizer that recognizes a character contained in the document image,
wherein the information acquirer acquires the information having high relevance to the document image, through the search engine using a character group recognized by the character recognizer, as the search criterion.

9. The document reading apparatus according to claim 8,
wherein, when the word extractor is unable to extract a word that satisfies a predetermined word extracting condition, from the information having high relevance acquired by the information acquirer using the document image represented by the image data as the search, the information acquirer acquires the information having high relevance to the document image, using the character group recognized by the character recognizer as the search criterion.
